(19) United States
(12) Patent Application Publication
(10) Pub. No.: US 2009/0108045 A1
(43) Pub. Date: Apr. 30, 2009

(54) HIGH SPEED TICKET DISPENSER

(76) Inventor: Stephen Shoemaker, JR., Redondo Beach, CA (US)

Correspondence Address: FULWIDER PATTON LLP, 6060 CENTER DRIVE, 10TH FLOOR, LOS ANGELES, CA, 90045, US

(21) Appl. No.: 11/927,180

(22) Filed: Oct. 29, 2007

(51) Int. Cl. G07F 11/00

(52) U.S. Cl. 226/195

(57) ABSTRACT

A redemption ticket dispenser is disclosed having a ticket path defined by a series of interchangeable rollers to accommodate different width tickets, the dispenser having a pair of pinch rollers disposed at the mouth of the dispenser to pull tickets through the dispenser and out of an arcade game. The pinch rollers are mounted on a pivoting arm that is held in place by a removable tensioning member. With the tensioning member removed, the pivoting arm can be rotated out of the ticket path to allow ticket jams to be cleared without removing the dispenser from its housing.

### BACKGROUND OF THE INVENTION

The present invention relates generally to ticket dispensing mechanisms, and more particularly to a high speed ticket dispenser for use in arcade type games and the like.

### SUMMARY OF THE INVENTION

Ticket dispensers are used in many fields including transportation, entertainment, sports, and particularly in the field of arcade games. Arcade games award players redemption tickets based on performance or luck in various games designed to distribute such tickets, which are then redeemed for prizes offered at the arcade.

In a typical redemption-type arcade game, a ticket dispenser is positioned at a front panel or in a game unit, where players have easy access to dispensed tickets. Generally, a supply such as a roll or fanfold of tickets is stored in a supply cache or compartment near the ticket dispenser within a game unit. The operator of the game can replace tickets when the supply is exhausted. The tickets are routed from the supply, through the ticket dispenser, and to a front opening or slot in the game unit through which the tickets are dispensed. The ticket dispenser may include one or more motor-driven rollers which can move the strip of tickets to and through the slot.

Other features and advantages of the invention will become apparent from the following detailed description, taken in conjunction with the accompanying drawings which illustrate, by way of example, the features of the invention

### BRIEF DESCRIPTION OF THE DRAWINGS

FIG. 1 is side view of the ticket dispenser of the present invention;

FIG. 2 is a side view of the ticket dispenser with the pinch roller pivoted out of the way to clear a ticket jam;

FIG. 3 is a front view of the ticket dispenser of FIG. 1;

FIG. 4 is an enlarged view of the rollers of the present invention showing interchangeability; and

FIG. 5 is an elevated perspective view of the ticket dispenser of FIG. 1.

### DETAILED DESCRIPTION OF THE PREFERRED EMBODIMENTS

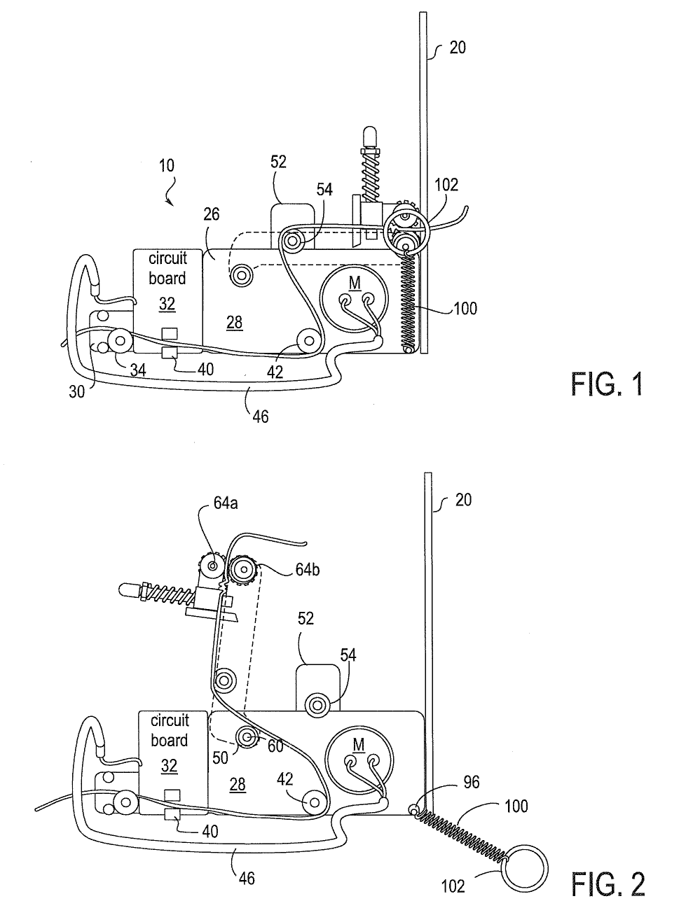

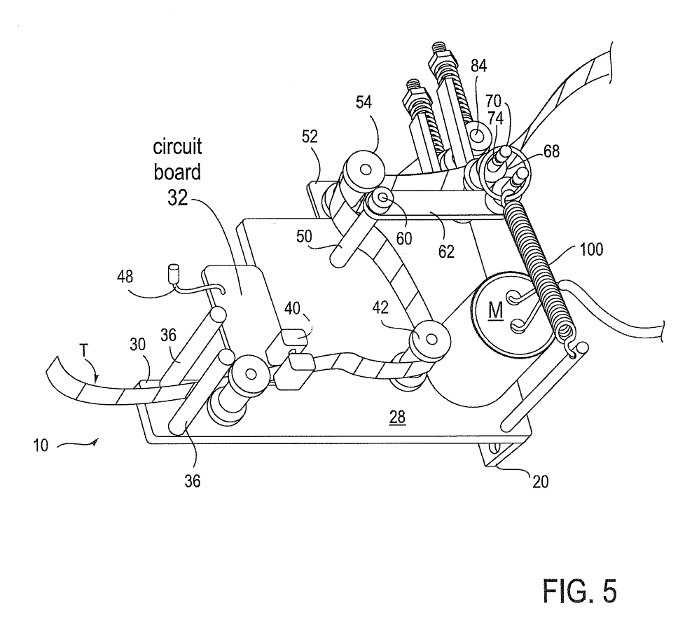

The ticket dispenser 10 of the present invention is generally shown in FIGS. 1 and 5 depicting a vertical mounting plate 20 adapted to secure the ticket dispenser 10 to a door or wall of an arcade game cabinet. The vertical mounting plate 20 includes an upper mounting hole 22 for receiving a first fastener, and a lower mounting hole 24 for receiving a second fastener to secure the ticket dispenser in the orientation shown in FIG. 1. Extending horizontally from the vertical mounting plate is a support bracket 26 comprised of two sections, a motor support plate 28 and a circuit board support plate 30. Of course, the two plates can easily be combined into a single plate for purposes of this invention. The circuit board support plate 30 extends out laterally from the motor support plate 28 and includes a circuit board mounting hole for receiving a fastener 31 that affixes the circuit board 32 to the circuit board support plate 30. At a distal end of the circuit board support plate 30, a lead roller hole receives a fastener that secures a horizontally disposed lead roller 34. A pair of ticket guides 36 extend horizontally in a parallel relationship adjacent the lead roller 34 to guide the tickets T into the dispenser. The tickets T are initially received through the ticket guides 36 and positioned in the proper ticket path by a lead roller 34 extending horizontally from said circuit board support plate 30. The lead roller 34 is exchangeable in that other rollers 34a (see FIG. 4) having a greater or lesser width which can be used for different width tickets.

The circuit board plate 30 mounts the circuit board 32 used to count the tickets T as they are dispensed by the machine. The circuit board 32 may be of the type manufactured by Xiamen Product Development Company Ltd. of Xiamen, China (PN0152487), and includes an optical sensor 40 positioned at the lower edge of the board to detect the tickets as they pass by the circuit board 32. The optical sensor is positioned just aft of the lead roller 34 between the lead roller 34 and a secondary roller 42 in the path of the ticket travel. As the ticket T passes by, the optical sensor 40 reads either a notch or a bar code imprinted on the outer edge of the ticket to maintain a count of the tickets being dispensed. The circuit board 32 is coupled by a first electrical cable 46 to the motor M for controlling the motor that drives the ticket dispenser and providing power to the Motor M. The motor can be a twelve volt, 120 rpm DC motor such as those offered by Jye Maw of Taiwan. A second electrical cable 48 connects the circuit board 32 to a main processor (not shown) in the arcade game which signals to the ticket dispenser 10 how many tickets to dispense to the player.

The motor support plate 28 includes an extension plate 52 extending vertically from an upper edge with a hole for receiving a threaded fastener that mounts a tertiary ticket roller 54. The tertiary ticket roller 54 is substantially vertically aligned with the secondary ticket roller 42, such that tickets travel substantially vertically upwards from the secondary ticket roller 42 to the tertiary ticket roller 54. As with the lead roller, the secondary roller and tertiary roller are replaceable with larger or smaller rollers to accommodate varying size tickets.

The motor support plate 28 further supports a cylindrical shaft 50 extending orthogonally approximately two inches, where the cylindrical shaft 50 is mounted about one and one half inches above the secondary roller 42. The cylindrical shaft is journalled on a cylindrical rod 60 that enables the shaft 50 to rotate freely about the rod 60. A stop at the end of the rod 60 maintains the cylindrical shaft 50 on the rod while allowing enough play to provide free rotation of the shaft about the rod. Mounted on the shaft 50 is an arm 62 that carries a pair of pinch rollers 64 at a distal end, where the pinch rollers 64 are horizontally aligned with the tertiary roller 54. The lower half 64b of the pinch roller 64 is mounted in a bracket extending horizontally from the arm 62, and is journalled within an annular collar 68 on a first side for receiving the axel 70 of the lower half 64b of the pinch roller 64, and a plate the receives the axel 70 on the other side. The axel 70 of the lower half 64b of the pinch roller 64 can include a circumferential recess 74 at an outer edge. Between the plate 28 and the lower half 64b of the pinch roller 64 is a toothed gear 76 for driving the pinch roller. The lower half of the pinch roller 64 may include a rubber band 78 to increase the friction of the rollers which resist slip as the tickets pass through. The upper half 64a of the pinch roller 64 is mounted to a carrier bracket 80 with a collar 82 on a first side for receiving the axel 84 of the upper half 64a of the pinch roller 64 and a plate 86 on the opposite side for receiving the axel 84, where the upper half 64a of the pinch roller 64 further carries a toothed gear 88 for engaging the complimentary toothed gear 76 on the lower half of the pinch roller 64 to drive both halves of the pinch rollers in opposite directions to move the tickets therebetween. The carrier bracket 80 is mounted on two vertical threaded fasteners 90 with a nut 92 at the top end. Between the carrier plate 80 and the nuts 92 are coil springs 94 that apply pressure on the upper half 64a of the pinch roller 64 so as to force the upper half against the lower half of the roller. By rotating the nuts 92 in either direction, more or less tension can be applied to the upper half 64a of the pinch roller to adjust the tension as needed to pull the tickets T through the dispenser.

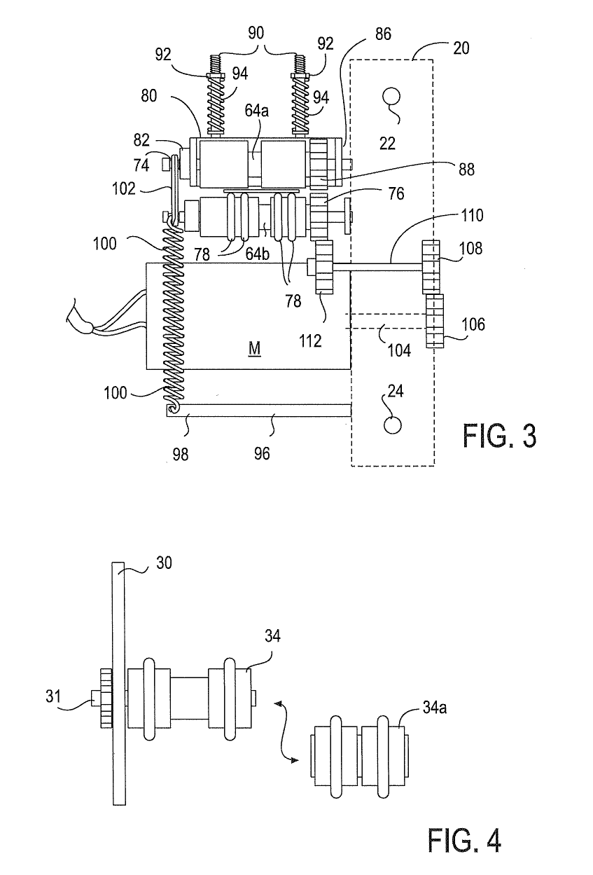

Extending from the bottom of the motor support plate 28 is an anchor rod 96, which is connected at its distal end 98 to a tensioning spring 100. At the end of the tensioning spring 100 is a ring 102 that fits over the axel 70 of the lower half 64b of the pinch roller 64 and sits in the circumferential recess 74. With the tensioning spring 100 connecting the anchor rod 96 to the pinch roller 64, the pinch roller 64 is fixed in its position shown in FIG. 3 and 5. This is the position for normal operation of the ticket dispenser. However, with the ticket dispenser 10 housed inside an arcade game, if a ticket jam occurs the previous art required that the ticket dispenser be removed. In the present embodiment, the ticket jam can be remedied by disconnecting the tensioning spring 100 from the pinch roller 64, which frees the arm 62 and pinch roller 64 to rotate away from the motor to expose the ticket path. As shown in FIG. 2, the rotation of the pinch rollers 64 back away from the front of the ticket dispenser exposes the entire ticket path through the dispenser and allows a maintenance worker to quickly and easily clear any ticket jams without removing the ticket dispenser from the game. Once the ticket path is cleared and the jam removed, the arm can be rotated downward to its original position and the tensioning spring replaced so that the ticket dispenser can resume operation.

The motor M is mounted to the motor support plate 28 such that a drive shaft 104 passes through the support plate 28 and carries a toothed drive gear 106. The drive gear 106 is coupled to a smaller follower gear 108 mounted on a support shaft 110 passing through the motor support plate 28. As the motor M drives the drive shaft 104 and drive gear 106, the follower gear 108 and support shaft 110 are turned, which in turn drives a second drive gear 112 on the opposite side of the motor support plate 28. The second drive gear 112 turns the associated gear 76 on the lower half of the pinch rollers 64 positioned to be aligned with the tertiary ticket roller 54. The cooperating gear 88 on the upper half 64a of the pinch roller 64 turns with the lower half's gear so that both halves 64a,b of the pinch rollers 64 turn in opposite directions to “pull” the line of tickets T therebetween. The surface of the pinch rollers may be textured in addition to the frictional band 78 to increase the friction and prevent slippage of the tickets.

The foregoing description of the ticket dispenser is intended to be illustrative and not limiting, in that those of ordinary skill in the art will readily recognize and appreciate that alternative embodiments and substitutions are possible without deviating from the scope of the invention. Therefore, the invention should not be limited in any manner by the foregoing, but rather the scope of the invention is intended to be measured by the appended claims in view of the description above.

I claim:

1. A high speed ticket dispenser comprising:
a plurality of ticket rollers cooperating to guide a strip of tickets along an intended path;
a circuit board including ticket counting means for counting a quantity of tickets dispensed;
a motor coupled to said circuit board, said motor including a drive gear for rotational movement about a first axis;
first and second pinch rollers having respective first and second pinch roller gears, said pinch roller gears coupled to said driver gear of said motor to rotate said pinch roller gears in opposite directions; and
a pivot arm carrying said pinch rollers, said pivot arm configured for angular displacement about a fixed support rod to rotate both of said pinch rollers from an operational position to a jam-clearing position; and
a tensioning member for biasing said pivoting arm to maintain said pinch rollers in said operational position, said tensioning member being manually disconnectable to allow said pivoting arm to be manually rotated to move said pinch rollers from said operational position to said jam-clearing position.

2. The high speed ticket dispenser of claim 1 further comprising first and second tensioning springs coupled to said first pinch roller to said second pinch roller, said tensioning springs being adjustable to adjust the tension of said first and second pinch rollers.

3. The high speed ticket dispenser of claim 1 wherein said plurality of ticket rollers are removable to allow replacement ticket rollers to be mounted on said ticket dispenser to dispenser alternate size tickets.
